(19) United States
(12) Patent Application Publication
(10) Pub. No.: US 2005/0183022 A1
(43) Pub. Date: Aug. 18, 2005

(54) System, method and program product for control of a presentation

(75) Inventors: Edward E. Kelley, Wappingers Falls, NY (US); Franco Motika, Hopewell Junction, NY (US); Tijs Wilbrink, Voorburg (NL)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY (US)

(21) Appl. No.: 10/777,961

(22) Filed: Feb. 12, 2004

(51) Int. Cl. G06F 3/00

(52) U.S. Cl. 715/751; 715/732; 715/855; 715/752; 715/758; 715/730

(57) ABSTRACT

A system, method and program product for making a presentation of screens to one or more invitees. A preliminary sequence of screens is defined to a computer. Before presenting one of the screens in the sequence to the one or more invitees, the computer presents to a presenter the one screen. Subsequently, the presenter decides whether to present the one screen to the one or more invitees and conveys the decision about the one screen to the computer. If the presenter decides to present the one screen to the one or more invitees, then the computer sends the one screen to a display device for each of the one or more invitees. If the presenter decides not to present the one screen to the one or more invitees, then the computer does not send the one screen to the display devices for the one or more invitees whereby the one or more invitees will not see the one screen. The one screen is presented to the presenter on a computer local to the presenter, one of the display devices is a projector local and coupled to the presenter's computer and another of the display devices is a computer remote from but coupled to the local computer. The foregoing process is then repeated for the next screen in the sequence.

### BACKGROUND

The invention relates generally to computer systems, and deals more particularly with a system, method and program product for a user to control a presentation made with a computer.

Various computer programs, such as Microsoft PowerPoint program and IBM Lotus Freelance program, are known today for making presentations electronically to local and remote audiences. The presentation is prepared beforehand (usually by the presenter) as a series of computer screens. Different people at different locations can be invited by e-mail or otherwise to attend the presentation electronically. Shortly before the time of the scheduled presentation, the remote invitees request and obtain access to the presentation by requesting the home page for the presentation web site, and then identifying the presentation they wish to attend and entering their name and/or a password. Typically, the remote invitees also dial-in to a conference call telephone number so that the presenter can speak to them as the speaker presents different presentation screens. The presenter has a laptop computer with a file containing the computer screens of the presentation. The laptop computer is connected by a network such as the Internet to a local projector and remote computers of the invitees. The laptop computer can send the computer screens to the projector and the remote computers based on their IP address. The local invitees meet in the same room as the presenter and will view the presentation on a “wall-type” or “pull-down” screen illuminated by the projector. The presenter, using a computer interface, selects the first screen to be presented to the local and remote invitees via the local projector and remote computers, respectively. This screen is displayed simultaneously to both the presenter and local audience via the local projector, and to the remote audience via the displays of their remote computers (either personal computers or lap top computers). After narrating the first screen, the presenter will ordinarily advance to the next screen, which is displayed simultaneously to both the presenter and local audience, and the remote audience. This process is repeated until all the screens are presented, or the presenter ends the presentation.

While the foregoing process for making the presentation is effective, in some cases, the presenter, at the time of the presentation, prefers not to display one or more screens within a sequence. However, the presenter may not remember the content of each screen before it is displayed, and so will not know ahead of the presentation of the screen that a screen should not be presented to the invitees.

Accordingly, an object of the present invention is to improve control by the presenter of which screens to present to the invitees.

### SUMMARY

The invention resides in a system, method and program product for making a presentation of screens to one or more invitees. A preliminary sequence of screens is defined to a computer. Before presenting one of the screens in the sequence to the one or more invitees, the computer presents to a presenter the one screen. Subsequently, the presenter decides whether to present the one screen to the one or more invitees and conveys the decision about the one screen to the computer. If the presenter decides to present the one screen to the one or more invitees, then the computer sends the one screen to a display device for each of the one or more invitees. If the presenter decides not to present the one screen to the one or more invitees, then the computer does not send the one screen to the display devices for the one or more invitees whereby the one or more invitees will not see the one screen. The foregoing process is then repeated for the next screen in the sequence.

According to other features of the present invention, the one screen is presented to the presenter on a computer local to the presenter, one of the display devices is a projector local and coupled to the presenter's computer and another of the display devices is a computer remote from but coupled to the local computer.

### BRIEF DESCRIPTION OF THE FIGURES

FIG. 1 is a block diagram of a distributed computer system embodying the present invention.

FIG. 2 is a block diagram of a presenter's computer within the distributed computer system of FIG. 1.

FIGS. 3(a) and (b) form a flow chart illustrating the steps performed by the presenter and a presentation program within the presenter's computer of FIG. 2, according to the present invention.

FIG. 4 is a table illustrating IP addresses of local and remote computers used by invitees to view the presentation.

### DETAILED DESCRIPTION OF THE PREFERRED EMBODIMENTS

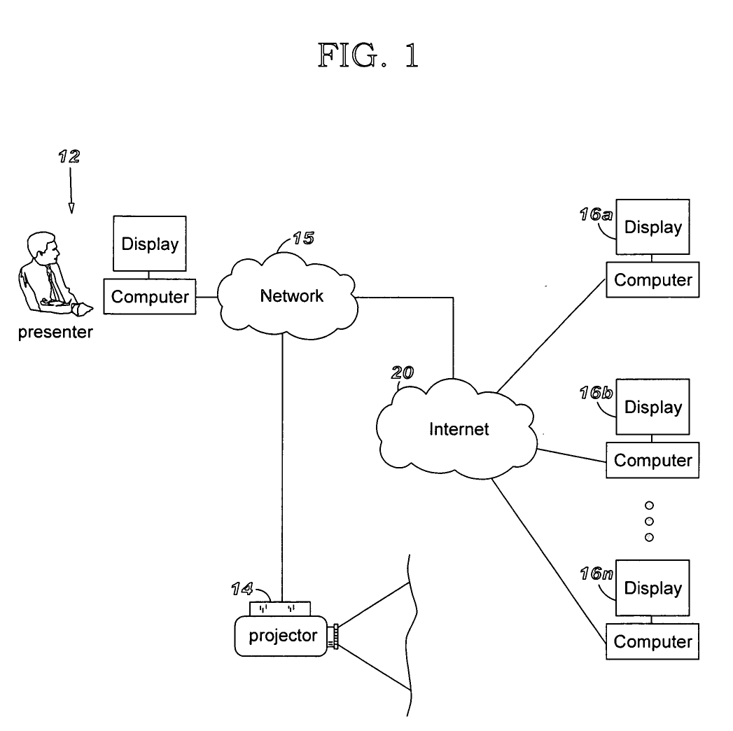

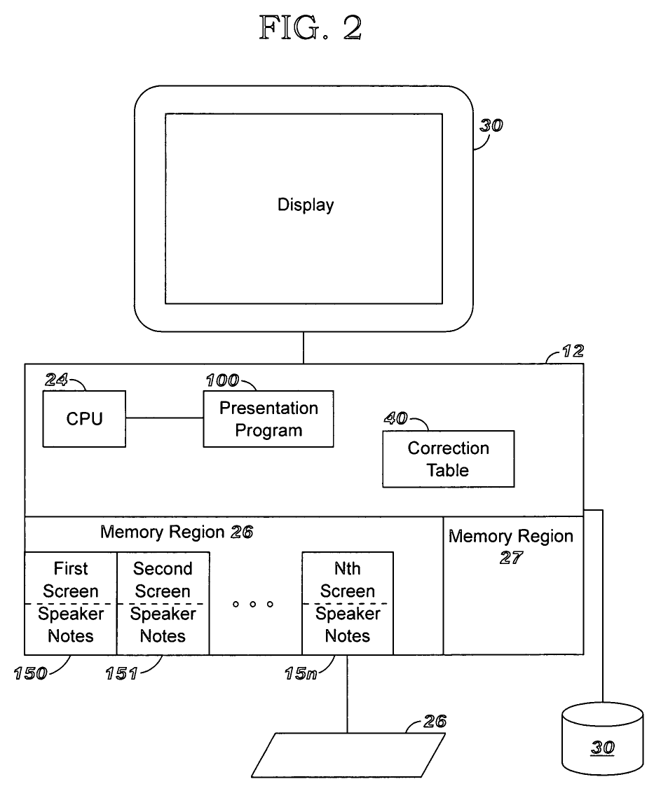

The invention will now be described in detail with reference to the figures. FIG. 1 illustrates a distributed computer system generally designated 10 in accordance with the present invention. Computer system 10 comprises a presentation control computer 12 coupled to a local projector 14 via a local network 15. However, alternately, presentation control computer 12 can be coupled to local projector 14 via the Internet. Presentation control computer 12 is typically a laptop computer, although could be a desktop computer as well. Computer system 10 also comprises a plurality of remote computers 16a,b,c coupled by a network 20 (such as the Internet) directly to the local computer 12 or indirectly to the local computer 12 via network 15 (as shown). The projector 14 is a type that projects what appears on the display of local computer 12. For example, projector 14 can be an IBM “Ultra Portable” projector Model iL2215. As illustrated in FIG. 2, presentation control computer 12 includes typical computer hardware such as a CPU 24, memory regions 26 and 27, external disk storage 30, keyboard 26 and display screen 30. Presentation control computer 12 also includes a presentation program 100 according to the present invention.

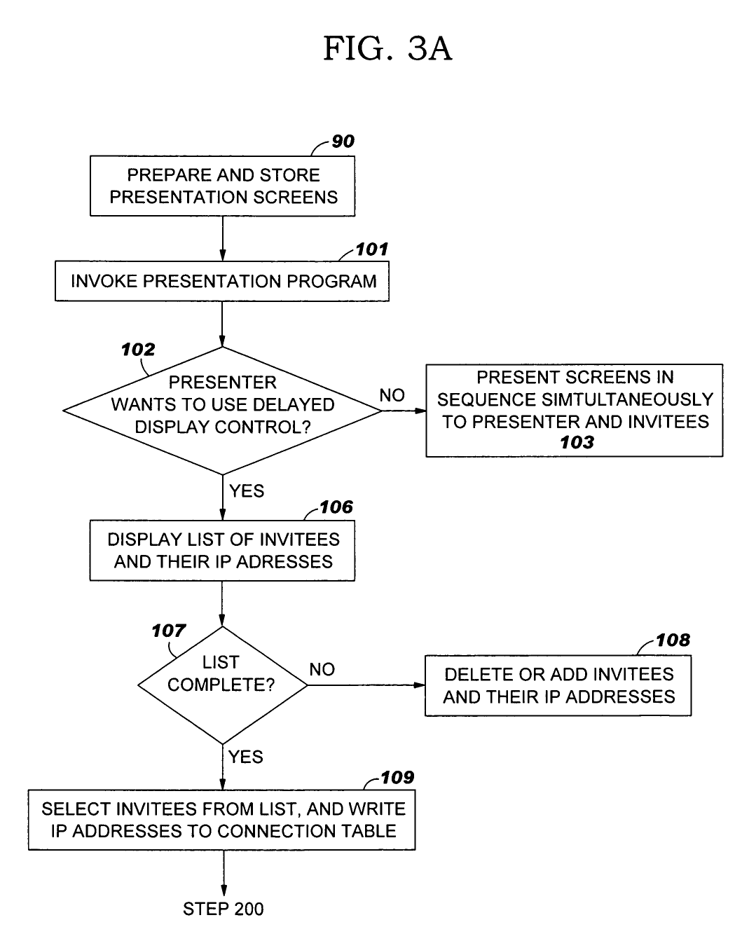

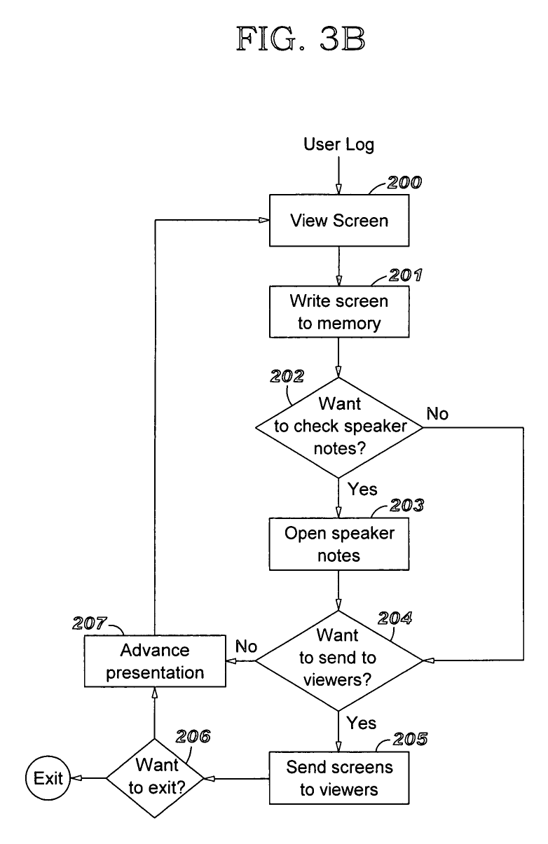

FIGS. 3(A) and 3(B) illustrate the steps performed by the presenter and the presentation program 100 in implementing the present invention. Initially, the presenter prepares and stores a “preliminary” sequence of display screens 150, 151, . . . 15n as pages in a softcopy file (step 90). Then, the presenter invokes the presentation program 100 (step 101). In response, the presentation program 100 queries the presenter whether the presenter wants to use the “delayed display” control feature of the presentation program 100 (decision 102). If not (decision 102, no branch), the screens are displayed in sequence when advanced by the presenter according to the prior art Microsoft PowerPoint program or IBM Lotus Freelance program (step 103). The screens are advanced by selecting a “page down” key on the keyboard. In the prior art Microsoft PowerPoint program and IBM Lotus Freelance program, the screens are presented simultaneously to the presenter on the display 30 of the presentation computer 12, to the presenter and the local audience via the projector 14, and to the remote computers 16a,b . . . n for the remote audience.

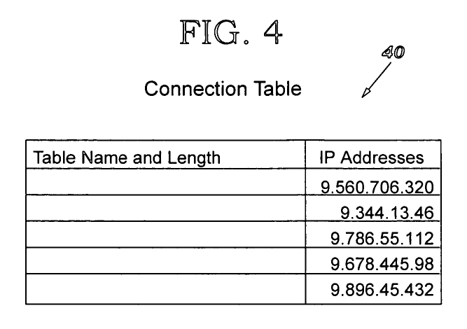

Referring again to decision 102, if the presenter wants to use the “delayed display” control feature of the presentation program 100 (decision 102, yes branch), the presentation program 100 displays a list of all the invitees of the presentation (step 106). For remote invitees, they are listed in a table by name of invitee, the term “remote computer” and the IP address of the remote computer that will display the screens. For local invitees, they are collectively listed by the term “local projector” and an IP address of the local projector 14. Next, the presentation program 100 queries the presenter whether the list of invitees is correct, i.e. whether any should be added or deleted (decision 107). If the list is not correct (decision 107, no branch), then the presenter can add to or delete from the list by manual entry (step 108). After step 108, or if the list was correct originally (decision 107, yes branch), then the presentation program 100 queries the presenter to select any or all of the entries on the list of invitees to participate in the presentation, i.e. receive the display screens when approved by the presenter (step 109). (Usually after step 108 or decision 107, yes branch, the presenter selects all of the entries on the list to receive the display screens.) Next, the presentation program 100 automatically displays on the local, presentation control computer 12 a first screen 150 in the preliminary sequence (step 200). The display page for the local computer 12 is typically read from a floppy disk (not shown), hard disk (not shown) or external storage 30 into a memory region 26. In accordance with the present invention, the first screen 150 which is already displayed on the presentation control computer 12, is not yet sent to the projector 14 or any of the remote computers 16a,b,c. Next, the presentation program copies the first screen to another memory region 27 (step 201). Next, the presentation program queries the presenter whether the presenter wants to view speaker notes (step 202). Speaker notes can be a summary of the verbal narration that the presenter will make when the screen is presented to the invitees, or other reminders or information that the speaker may need during the narration or subsequent questions raised by the invitees. If the presenter selects to view the speaker notes (decision 202, yes branch), then the presentation program 100 reads them from memory region 26 and displays them above, below or on an unused portion of the first display screen (step 203). Next, the presentation program 100 queries the presenter whether the presenter wants to send the first display screen to the invitees selected in step 109 (decision 204). If not (decision 204, no branch), then the presentation program loops back to step 200 and displays on the presenter's computer 12 the next screen 151 in the preliminary sequence (step 207). However, if the presenter selects to send the first display screen 150 to the invitees selected in step 109 (decision 204, yes branch), then the presentation program 100 reads the IP addresses of the invitees selected in step 109 and sends the screen 150 from memory region 26 to all of the invitees selected in step 109 (step 205). The IP addresses of the invitees are read from a table 40 shown in FIGS. 2 and 4. This screen which is sent to the computers of the invitees does not include the speaker notes. The transmission of the screen to the remote computers may utilize TCP/IP protocol. The transmission of the screen to the local projector 14 may also utilize TCP/IP protocol. Next, the presentation program 100 queries the presenter whether the presenter is done with the presentation (decision 206). If not, then the presentation program 100 loops back to step 200 and displays on the local computer 12 the next screen 151 in the preliminary sequence (step 207). The foregoing steps are repeated for each screen in the preliminary sequence.

In accordance with the objects of the present invention, each display screen before display to any of the invitees is displayed to the presenter only on the presenter's local “private” computer so that the presenter can refresh his or her personal memory as to the content of the display screen and decide at that time whether to present the display screen to the invitees.

Based on the foregoing, an improved presentation method, system and program product has been disclosed. However, numerous modifications and substitutions can be made without deviating from the scope of the present invention. Therefore, the present invention has been disclosed by way of illustration and not limitation, and reference should be made to the following claims to determine the scope of the present invention.

1. A process for making a presentation of screens to one or more invitees, said method comprising the steps of:
defining a preliminary sequence of screens to a computer;
before presenting one of said screens in said sequence to said one or more invitees, said computer presenting to a presenter said one screen; and
subsequently, the presenter deciding whether to present said one screen to said one or more invitees and conveying the decision about said one screen to said computer, and if the presenter decides to present said one screen to said one or more invitees, then said computer sending said one screen to a display device for each of said one or more invitees, and if said presenter decides not to present said one screen to said one or more invitees, then said computer not sending said one screen to the display devices for said one or more invitees whereby said one or more invitees will not see said one screen.

2. A process as set forth in claim 1 further comprising the following steps performed after the foregoing deciding and sending or not sending step:
before presenting a next one of said screens in said sequence to said one or more invitees, said computer presenting to the presenter said next screen; and
the presenter deciding whether to present said next screen to said one or more invitees and conveying the decision about said next screen to said computer, and if the presenter decides to present said next screen to said one or more invitees, then said computer sending said next screen to a display device for each of said one or more invitees, and if said presenter decides not to present said next screen to said one or more invitees, then said computer not sending said next screen to the display devices for said one or more invitees whereby said one or more invitees will not see said next screen.

3. A method as set forth in claim 2 wherein said one and next screens are presented to said presenter on a computer local to said presenter, and one of said display devices is a computer remote from but coupled to said local computer.

4. A method as set forth in claim 2 wherein said one and next screens are presented to said presenter on a computer local to said presenter, and further comprising the steps of presenting to said presenter on said one screen presenter notes for said one screen and presenting to said presenter on said next screen presenter notes for said next screen, said presenter notes for said one screen and presenter notes for said next screen not being presented to said one or more invitees even if said presenter decides to present said one and next screens to said one or more invitees.

5. A method as set forth in claim 2 wherein said one and next screens are presented to said presenter on a computer local to said presenter, one of said display devices is a projector local and coupled to said local computer and another of said display devices is a computer remote from and coupled to said local computer.

6. A method as set forth in claim 1 wherein said one screen is presented to said presenter on a computer local to said presenter, and one of said display devices is a projector local and coupled to said local computer.

7. A method as set forth in claim 6 wherein another of said display devices is a computer remote from said presenter.

8. A computer program product for controlling a presentation of screens to one or more invitees, said computer program product comprising:
a computer readable medium;
first program instructions to receive a preliminary sequence of presentation screens;
second program instructions to present one of said screens in said sequence to a computer or display device of a presenter before sending said one screen to one or more other computers or other display devices to present to said one or more invitees, respectively; and
third program instructions to receive a decision from the presenter, after said one screen is presented to said presenter, whether to present said one screen to said one or more invitees and, if the presenter decides to present said one screen to said one or more invitees, then said third program instructions directs that said one screen be sent to said one or more other computers or other display devices to present said one screen to said one or more invitees, and if said presenter decides not to present said one screen to said one or more invitees, then said third program instructions does not direct that said one screen be sent to said one or more other computers or other display devices of said one or more invitees whereby said one or more invitees will not see said one screen; and
wherein said first, second and third program instructions are recorded on said medium.

9. A computer program product as set forth in claim 8 wherein said one or more other computers or display devices is a projector local to said presenter and coupled to said computer or display device of said presenter.

10. A computer program product as set forth in claim 9 further comprising fourth program instructions to display program notes in or with said one screen to said presenter on said computer or display device of said presenter, said presenter notes not being presented to said one or more invitees even if said presenter decides to present said one screen to said one or more invitees; and wherein said fourth program instructions are recorded on said medium.

11. A computer system for controlling a presentation of screens to one or more invitees, said computer system comprising:
means for receiving a preliminary sequence of presentation screens;
means for presenting one of said screens in said sequence to a computer of a presenter before sending said one screen to one or more other computers to present to said one or more invitees, respectively; and
means for receiving a decision from the presenter, after said one screen is presented to said presenter, whether to present said one screen to said one or more invitees and, if the presenter decides to present said one screen to said one or more invitees, then directing that said one screen be sent to said one or more other computers to present said one screen to said one or more invitees, and if said presenter decides not to present said one screen to said one or more invitees, then said system does not direct that said one screen be sent to said one or more other computers of said one or more invitees whereby said one or more invitees will not see said one screen.
